(19) United States
(12) Patent Application Publication
(10) Pub. No.: US 2009/0091052 A1
(43) Pub. Date: Apr. 9, 2009

(54) Method of monitoring the performance of a pressure intensifier

(75) Inventor: Jago Pridie, Bristol (GB)

Correspondence Address: NIXON & VANDERHYE, PC, 901 NORTH GLEBE ROAD, 11TH FLOOR, ARLINGTON, VA, 22203, US

(73) Assignee: AIRBUS UK LIMITED, Bristol (GB)

(21) Appl. No.: 12/232,223

(22) Filed: Sep. 12, 2008

(30) Foreign Application Priority Data
Oct. 4, 2007 (GB) 0719267.7

(51) Int. Cl. B28B 17/00; B29C 45/76

(52) U.S. Cl. 264/40.5; 425/149

(57) ABSTRACT

A method of monitoring the performance of a pressure intensifier for use in the manufacture of a composite part. The method comprises: placing an array of pressure sensors adjacent a curved region of a mould tool; compressing the pressure sensors between a pressure intensifier and the mould tool; and monitoring the distribution of pressure across the curved region of the mould tool with the array of pressure sensors.

### FIELD OF THE INVENTION

The present invention provides a method and apparatus for monitoring the performance of a pressure intensifier for use in the manufacture of a composite part.

### BACKGROUND OF THE INVENTION

Pressure intensifiers are commonly used in the manufacture of a composite part in either a forming, debulking and/or curing step. The pressure intensifier typically compresses a composite charge against a curved region of a mould tool, in order to control the thickness of the charge in that region. Examples of the use of such pressure intensifiers are described in US 2002/0012591 A1 (in which the pressure intensifier comprises a membrane which is draped over a male mould tool) and US 2006/0017200 (in which the pressure intensifier comprises a pressing device which presses the charge against the internal corner of a female mould tool).

Presently the performance of such intensifiers can only be monitored by manufacturing a part, and observing the results. This can be time consuming and expensive, and may not give a reliable indication of the performance of the pressure intensifier.

### SUMMARY OF THE INVENTION

A first aspect of the invention provides a method of monitoring the performance of a pressure intensifier for use in the manufacture of a composite part, the method comprising:
placing an array of pressure sensors adjacent a curved region of a mould tool;
compressing the pressure sensors between a pressure intensifier and the mould tool; and
monitoring the distribution of pressure across the curved region of the mould tool with the array of pressure sensors.

The mould tool may comprise a male tool with a convex curved region. In this case typically the pressure intensifier comprises a diaphragm having a first part which is positioned above a top of the male tool and a second part which projects to one side of the male tool; and the pressure sensors are compressed between the diaphragm and the male tool by applying a pressure difference across the diaphragm and stretching the diaphragm over the male tool as the pressure difference is applied. Preferably the diaphragm is stretched over the male mould tool by bridging it over a channel next to the male tool whereby the pressure difference draws the diaphragm into the channel. Preferably a top of the male tool meets a side of the male tool at a convex corner with a relatively high curvature; and the array of pressure sensors includes one or more sensors adjacent to the top of the male tool, one or more sensors adjacent to the side of the male tool, and or more sensors adjacent to the convex corner of the male tool.

Alternatively the mould tool may comprise a female tool with a concave curved region. In this case typically the pressure intensifier comprises a pressing device which extends into the concave curved region.

Typically the array of pressure sensors are provided as part of a flexible mat.

A further aspect of the invention provides a method of moulding a charge during the manufacture of a composite part, the method comprising:
placing the charge and a diaphragm on a male tool, the charge having a first part which is positioned above a top of the male tool and a second part which projects to one side of the male tool;
placing an array of pressure sensors between the diaphragm and the male tool;
progressively deforming the second part of the charge against a side of the male tool by applying a pressure difference across the diaphragm and stretching the diaphragm over the male tool as the pressure difference is applied; and
monitoring the distribution of pressure across the mould tool with the array of pressure sensors.

Typically the charge comprises a stack of plies of composite material.

Typically each ply contains a set of fibres which are substantially aligned with each other.

Typically the method further comprises removing the deformed charge from the male tool; and curing it on a female tool.

Typically the composite part is an aircraft part.

### BRIEF DESCRIPTION OF THE DRAWINGS

Embodiments of the invention will now be described with reference to the accompanying drawings, in which:

FIG. 1 is a plan view of a male tool and a pair of edge bars;

FIG. 2 is a sectional view taken along line A-A in FIG. 1;

FIG. 3 is an enlarged portion of FIG. 2;

FIG. 4 is a sectional view through the male tool after the charge has been formed;

FIG. 5 is a sectional view through a female mould tool;

FIG. 6 is a sectional view of an alternative forming assembly;

FIG. 7 is a sectional view of a further alternative forming assembly;

FIG. 8 shows a first experiment for monitoring the performance of a diaphragm;

FIG. 9 shows a second experiment for monitoring the performance of a diaphragm; and

FIG. 10 shows a concave corner intensifying arrangement underneath a vacuum bag.

### DETAILED DESCRIPTION OF EMBODIMENT(S)

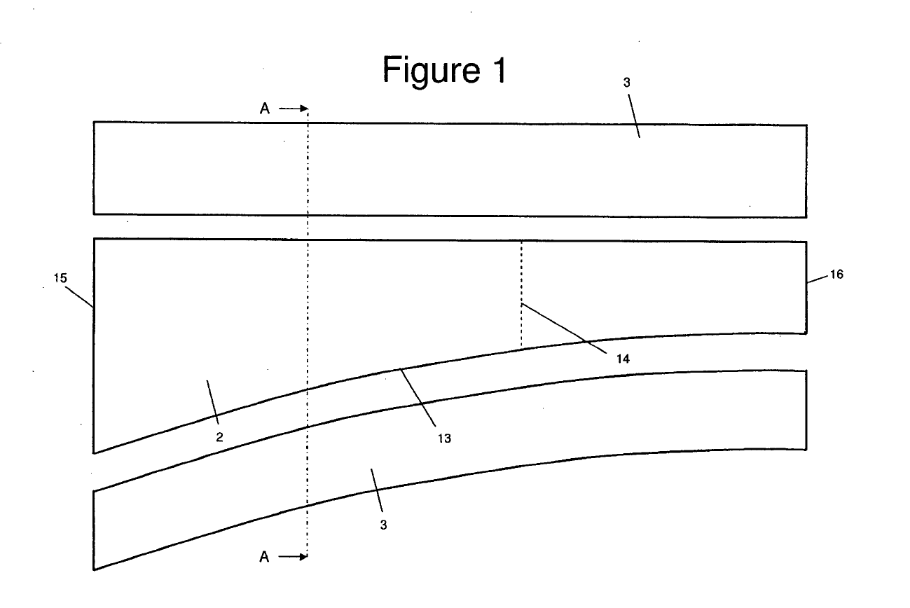

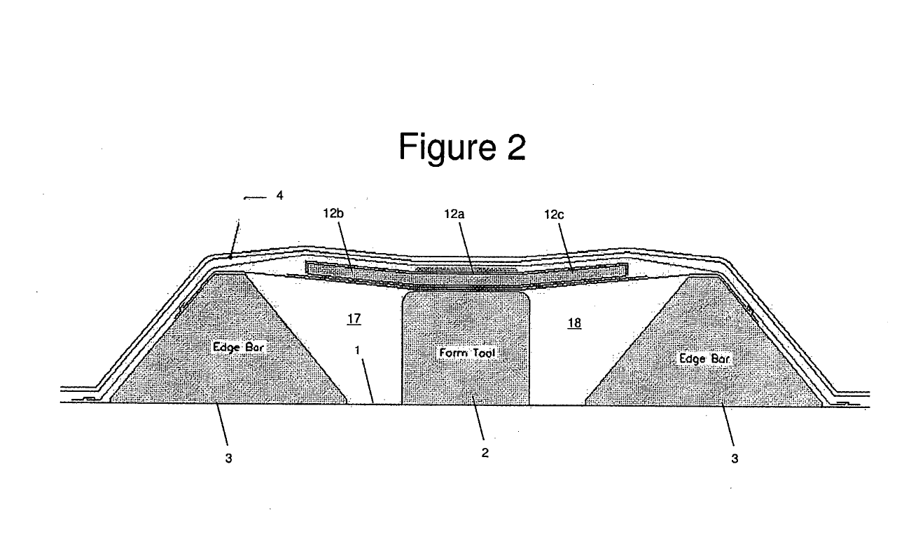

FIG. 1 is a plan view of a male moulding and debulking tool 2 and a pair of edge bars 3 which are used to form a C-section aircraft spar. FIG. 2 is a sectional view taken along line A-A in FIG. 1. As shown in FIG. 2, the tool 2 and edge bars 3 are mounted on a table 1.

In a first step, a planar sheet of composite prepreg is formed either by a tape-laying or other automated machine on a planar table (not shown). A planar prepreg charge 12 with the desired shape is then cut from the planar sheet. It will be appreciated that the prepreg charge 12 may be formed from a variety of suitable composite materials. In a preferred embodiment the charge is formed from an epoxy resin reinforced by uniaxial carbon fibres, such as T700/M21 manufactured provided by Hexcel (www.hexcel.com).

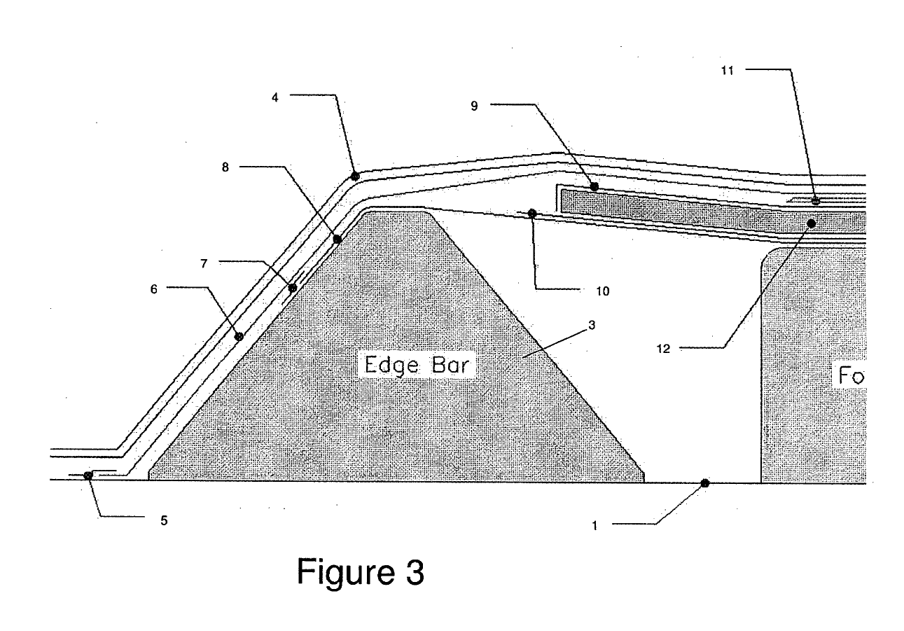

Referring to FIG. 3, a flexible support membrane 8 of Vacfilm 430 is draped over the tool 2 and edge bars 3, and secured to the edge bars 3 by strips of tape 7. Vacfilm 430 is a high stretch elastomeric bagging film available from Aerovac System Ltd (www.aerovac.com). The film has a relatively low tensile modulus of 700 psi (4.8 MPa) at 100% elongation. This is defined as the ratio of tensile stress to tensile strain when the film is subjected to a tensile force in the plane of the film, at 100% elongation.

The charge 12 is encased in two layers 9,10 of fluorinated ethylene propylene (FEP) release film and placed as shown in FIGS. 2 and 3. The charge has a central part 12a which is positioned above the top of the male tool, and side parts 12b, 12c which project on opposite sides of the male tool.

A caul plate 11 is placed on top of the charge and a two-layer diaphragm 4, 6 is draped over the assembly. The first layer of the diaphragm is a layer 6 of Wrightlon® WL7400 film which is draped over the assembly and secured to the table 1 by strips of tape 5. Wrightlon® WL7400 film is available from Airtech Advanced Materials Group, of Huntington Beach, Calif., USA. The diaphragm layer 6 has a tensile modulus higher than that of the support membrane 8. In addition, the tensile stiffness of the diaphragm layer 6 (which is related to the tensile modulus) in the plane of the diaphragm layer 6 is higher than that of the support membrane 8 in the plane of the support membrane 8. The second layer of the diaphragm is a low-stiffness layer 4 which is draped over the assembly and secured to the table 1 by a robust steel frame. The second diaphragm layer 4 may be formed from a variety of suitable resilient materials. In a preferred embodiment the diaphragm layer 4 is made of Mosite 1453D—a high strength silicone rubber manufactured by the Mosite Rubber Company of Fort Worth, Tex. This has a tensile modulus at 300% elongation of 600 psi (4.1 MPa).

Pressure is applied to the assembly by applying a vacuum via an array of small holes (not shown) in the table 1. The holes are distributed across the whole table so that the whole assembly is evacuated. In other words, the cavity between the support membrane 8 and the table 1 is evacuated, and the cavity between the support membrane 8 and the two-layer diaphragm 4,6 is evacuated, and the cavity between the diaphragm layers 4 and 6 is evacuated.

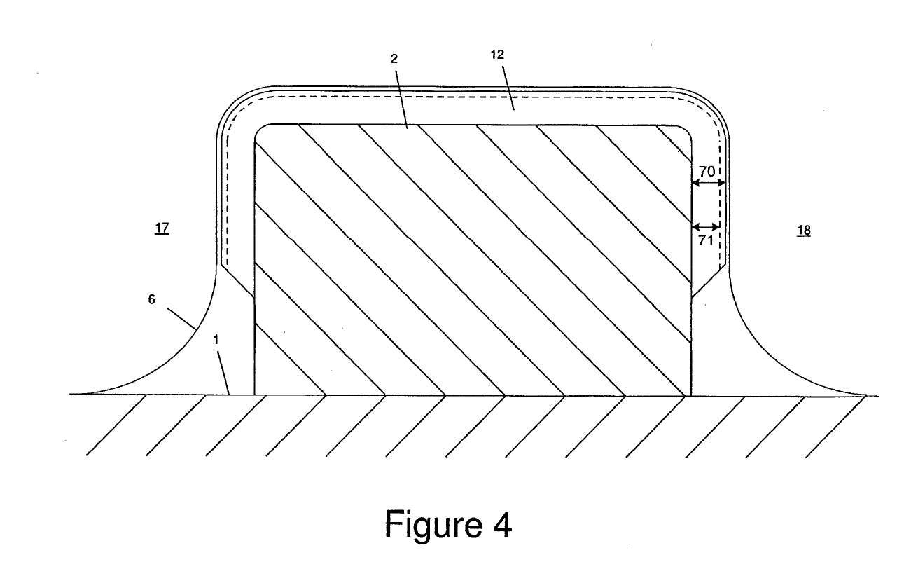

As shown in FIG. 4, the diaphragm is stretched over the male tool by bridging it over the channels 17,18 between the male tool 12 and the edge bars 3 whereby the pressure difference draws the diaphragm into the channels. As the diaphragm is drawn into the channels 17,18, they progressively deform the sides 12b,12c of the charge against the sides of the male tool as shown in FIG. 4. Forming may be performed at a high temperature T1 of 85° C.-95° C. (preferably 90° C.), or a lower temperature of 45° C. Note that for purposes of clarity the low-stiffness diaphragm layer 4, release films 9,10, caul plate 11 and film 8 are not shown in FIG. 4.

Heat may be applied by an oven, infrared heating element, or any other means. Optionally, additional debulking pressure may be provided by placing the assembly in an autoclave and applying pressure above 1 bar to the outer side of the diaphragm.

The support membrane 8 supports the weight of the sides 12b,12c of the charge as it approaches the forming and debulking temperature T1, avoiding a tendency to self form which can result in process wrinkles. The support membrane 8 also ensures that the spar flanges can only form as a catenary, which can otherwise cause process wrinkles.

The stiff diaphragm layer 6 and support membrane 8 place the charge 12 in tension, making it easier to mould it over ramps or other complex shapes on the male tool. Note that the diaphragm layers 4,6 are laid up in tension so as to minimise sag prior to the vacuum being applied.

The pressure difference across the diaphragm imparts a uniform hydrostatic pressure on all areas of the charge 12. The bridging of the diaphragm over the channels between the mould tool and the edge bars 3 causes the diaphragm to stretch, giving a stretching force in the plane of the diaphragm which is reacted by the charge where it engages the convex corners of the male tool. Thus the pressure applied to the charge varies over its surface between a pure hydrostatic pressure (up to atmospheric pressure, or beyond if an autoclave is used) where it engages the less convex approximately planar surface regions on the top and sides of the tool 2, and an intensified pressure at the convex high curvature corners comprising the stretching pressure added to the hydrostatic pressure. Thus the diaphragm acts as a pressure intensifier.

Debulking of the charge is caused by the combination of pressure and increased temperature. Debulking is also assisted by the action of the diaphragm which gradually moves down the sides 12b, 12c of the charge, squeezing excess air out of the charge.

FIG. 4 shows the outer profile of the charge prior to debulk in solid lines, and after debulk in dashed lines. The debulking process reduces the thickness of the charge from a thickness 70 prior to debulk, to a thickness 71 after debulk. Note that the thickness has reduced by a similar amount in both the non-planar and planar regions of the charge. In one embodiment the thickness 70 is about 34 mm and the thickness 71 is about 30 mm.

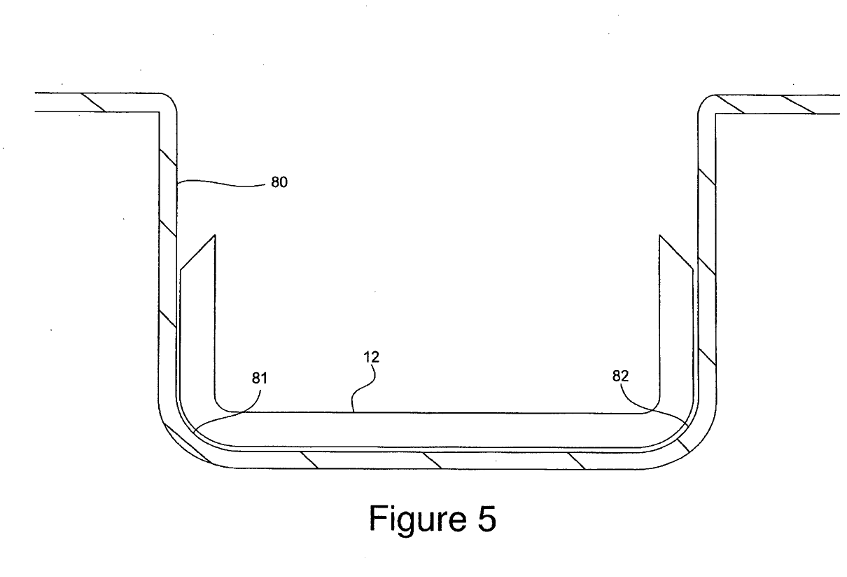

After debulking, the deformed charge 12 is transferred to a female curing tool 80 shown in FIG. 5, and relevant consumables applied to the IML of the charge 12. The tool 80 is then placed in an autoclave where it is heated to a curing temperature T2 of approximately 180° C. and pressurised to between 7 and 12 bar to cure the charge.

The charge on the female curing tool 80 is net thickness, which means that the IML surface of the charge does not have to move on cure. Therefore the thickness of the charge remains constant in the non-planar regions where the charge engages the convex corner surfaces 81,82 of the tool 80.

In an alternative process, instead of curing the charge on a female tool 80 as shown in FIG. 5, the charge may be cured on the male tool 2 which is used for moulding and debulking. In this case, sacrificial plies may be added to the Outer Mould line (OML) of the charge for machining in order to meet geometric tolerances. The hot debulking process controls the thickness of the male cured spar, and thus variability in the part is reduced and the thickness (or number) of sacrificial plies required is minimised.

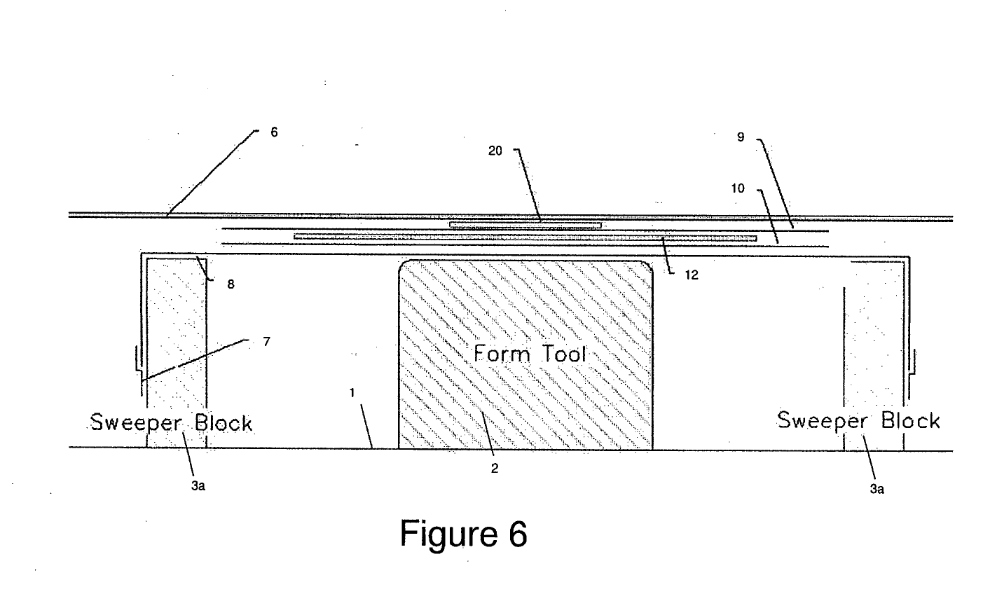

An alternative forming and debulking assembly is shown in FIG. 6. This is similar to the assembly of FIGS. 1-3 and similar features are given the same reference numeral. Note however that the low-stiffness diaphragm layer 4 and caul plate 11 are omitted, and a breather layer 20 is provided under the stiff diaphragm layer 6. Note also that rectangular sweeper blocks 3a are provided instead of the triangular edge bars 3 shown in FIGS. 1-3.

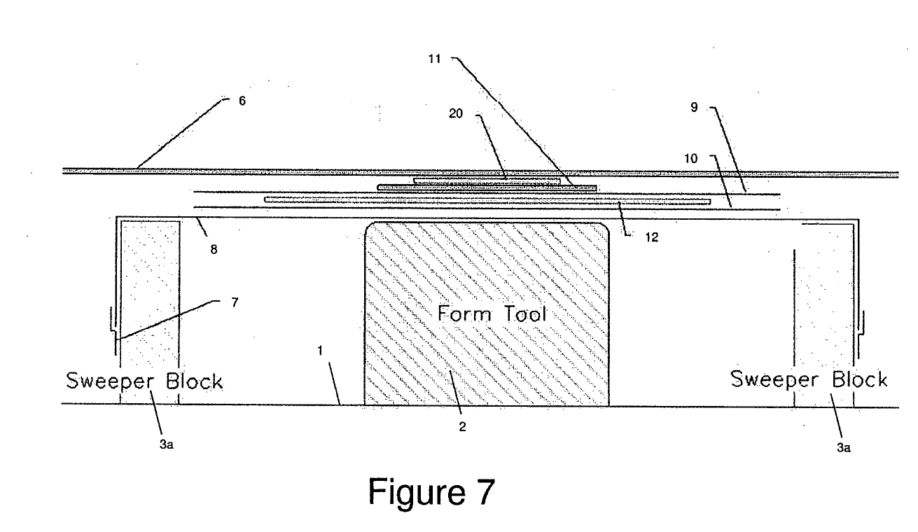

A further alternative forming and debulking assembly is shown in FIG. 7. This is similar to the assembly of FIG. 6 and similar features are given the same reference numeral. Note that in contrast with FIG. 7 a caul plate 11 is included.

Referring to FIG. 1, the tool 2 has a curved edge 13 with a large radius of curvature (of the order of 100 metres). Each layer of prepreg contains an array of carbon fibres which extend in one direction. Some of the prepregs are laid with their fibres extending in a spanwise direction between the root 15 and tip 16 of the spar. These are conventionally referred to as “zero fibres” since they are aligned at 0° to the spanwise direction. Others are laid with their fibres extending in a chordwise direction at right angles to the spanwise direction. Others are laid at an angle of +/−45 degrees to the spanwise direction. In a conventional assembly a wrinkle tends to form along a line 14 shown in FIG. 1. It is believed that this forms due to the zero fibres.

Surprisingly, it has been found that by using a diaphragm layer 6 which is relatively stiff, this wrinkle tends not to form. The low stiffness diaphragm layer 4 is resilient to repeated cycling, so can be re-used for a number of forming cycles. In contrast the high stiffness diaphragm layer 6, whilst achieving better laminate consolidation, may need to be replaced more frequently.

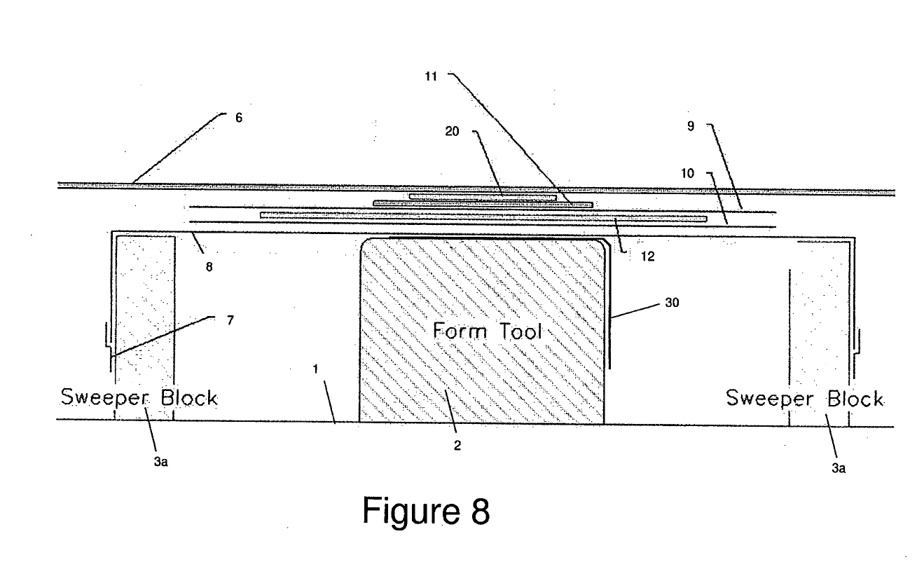

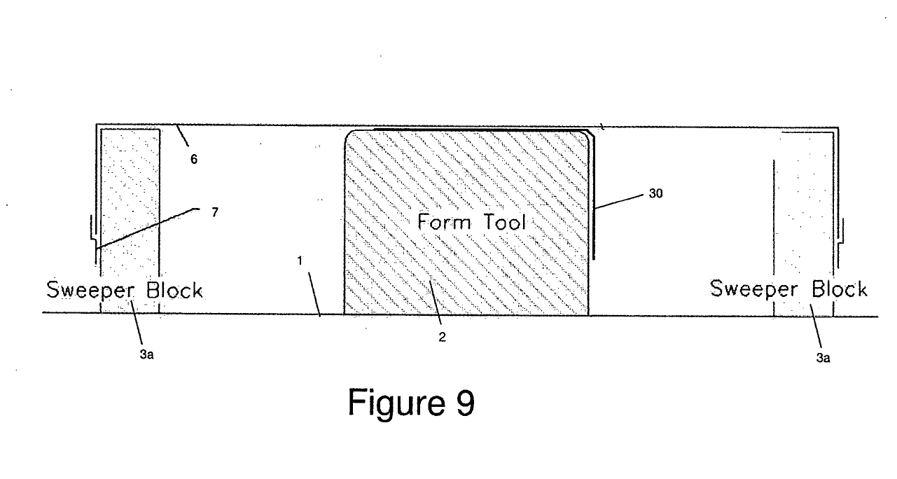

FIGS. 8 and 9 show two experiments for monitoring the performance of the diaphragm. FIG. 8 shows the assembly of FIG. 7 with the addition of a pressure sensor mat 30. The mat 30 comprises a Hugemat 5400N, available from Tekscan, Inc. of South Boston, Mass., USA. The mat 30 comprises a flexible mat containing an array of 1768 pressure sensors at a density of 0.3 sensors per square cm. FIG. 9 shows an experimental arrangement for monitoring the performance of the diaphragm 6 without the presence of the caul plate 11, plaque 12 or sheet 8.

In both cases the mat 30 is shown draped over only one corner of the male tool 2, but more preferably the mat 30 may be draped over both corners.

Experiments have been conducted with diaphragms 6 of varying stiffness, and it has been found that the greater the stiffness the greater the pressure which is applied at the convex corners of the male tool 2. That is, the output of the sensor array shows a more pronounced spike at the corner area when the diaphragm 6 is relatively stiff. Concentration of forces at the convex corners is desirable for both forming and debulking.

The pressure sensing arrangement shown in FIG. 9 offers huge benefit in terms of being able to rapidly optimize forming processes, without the need for manufacturing parts. It would also be advantageous for designing and evaluating pressure intensifiers again, without the need for lengthy manufacturing trials.

As well as providing a means of assessing the optimal stiffness for the diaphragm 6, the arrangement of FIG. 9 also provides a means of ascertaining whether the caul plate 11 is of any benefit to the forming process.

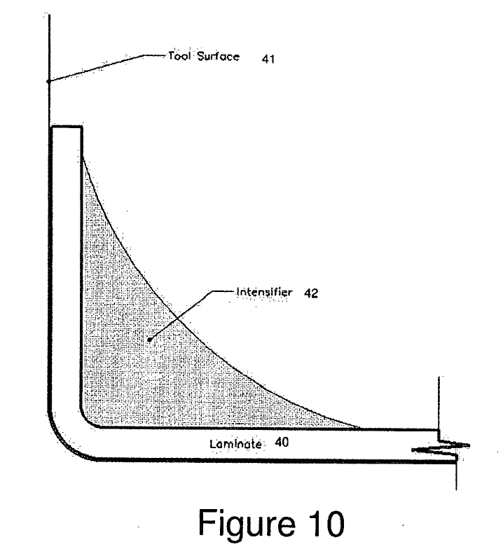

FIG. 10 illustrates a method of monitoring the performance of a pressure intensifier according to a further embodiment of the present invention. In this case a female mould tool with a tool surface 41 carries a laminate charge 40 such as a “C” spar. Note that only half of the mould tool and laminate charge are shown in FIG. 10—the other half being a mirror image. A pressing device 42 is mounted in the curved corner of the assembly. A layer of vacuum film such as WL7400 (not shown) is draped over the charge 40, and a pressure difference is applied across the diaphragm. This applies a hydrostatic pressure to the laminate 40. The pressing device 42 is pushed towards the corner region so as to increase the pressure applied to the laminate in the concave corner region and debulk the laminate and control its thickness. A pressure sensor mat (not shown) similar to the mat 30 is placed between the laminate 40 and the tool surface 41, or between the pressing device 42 and the laminate 40. Alternatively, the laminate 40 may be omitted, and the performance of the intensifier in the absence of the laminate may be monitored by placing the pressure sensor mat directly between the pressing device 42 and the tool surface 41.

The tool of FIG. 10 is subjected to a hot debulk cycle in an autoclave, at elevated pressure, in order to consolidate the laminate in the curved corner regions. The intensifier 42 may be removed prior to the cure stage, to avoid any problems which could occur such as marking of the laminate. Alternatively the intensifiers 42 may be designed with soft edges, so that they can remain against the laminate during the cure stage.

Although the invention has been described above with reference to one or more preferred embodiments, it will be appreciated that various changes or modifications may be made without departing from the scope of the invention as defined in the appended claims.

1. A method of monitoring the performance of a pressure intensifier for use in the manufacture of a composite part, the method comprising:
placing an array of pressure sensors adjacent a curved region of a mould tool;
compressing the pressure sensors between a pressure intensifier and the mould tool; and
monitoring the distribution of pressure across the curved region of the mould tool with the array of pressure sensors.

2. The method of claim 1 wherein the mould tool is a male tool with a convex curved region, the pressure intensifier comprises a diaphragm having a first part which is positioned above a top of the male tool and a second part which projects to one side of the male tool; and the pressure sensors are compressed between the diaphragm and the male tool by applying a pressure difference across the diaphragm and stretching the diaphragm over the male tool as the pressure difference is applied.

3. The method of claim 2 wherein the diaphragm is stretched over the male mould tool by bridging it over a channel next to the male tool whereby the pressure difference draws the diaphragm into the channel.

4. The method of claim 2 wherein a top of the male tool meets a side of the male tool at a convex corner with a relatively high curvature; and the array of pressure sensors includes one or more sensors adjacent to the top of the male tool, one or more sensors adjacent to the side of the male tool, and or more sensors adjacent to the convex corner of the male tool.

5. The method of claim 1 where the mould tool is a female tool with a concave curved region.

6. A method of moulding a charge during the manufacture of a composite part, the method comprising:
placing the charge and a diaphragm on a male tool, the charge having a first part which is positioned above a top of the male tool and a second part which projects to one side of the male tool;
placing an array of pressure sensors between the diaphragm and the male tool;
progressively deforming the second part of the charge against a side of the male tool by applying a pressure difference across the diaphragm and stretching the diaphragm over the male tool as the pressure difference is applied; and
monitoring the distribution of pressure across the mould tool with the array of pressure sensors.

7. The method of claim 6 wherein the diaphragm is stretched over the male mould tool by bridging it over a channel next to the male tool whereby the pressure difference draws the diaphragm into the channel.

8. The method of claim 6 wherein a top of the male tool meets a side of the male tool at a convex corner with a relatively high curvature; and the array of pressure sensors includes one or more sensors adjacent to the top of the male tool, one or more sensors adjacent to the side of the male tool, and or more sensors adjacent to the convex corner of the male tool.

9. The method of claim 1 wherein the array of pressure sensors are provided as part of a flexible mat.

10. Apparatus for monitoring the performance of a pressure intensifier for use in the manufacture of a composite part, the apparatus comprising:
a mould tool;
an array of pressure sensors adjacent a curved region of the mould tool; and
a pressure intensifier positioned to compress the pressure sensors against the curved region of the mould tool.
